(19) United States
(12) Patent Application Publication
(10) Pub. No.: US 2024/0360647 A1
(43) Pub. Date: Oct. 31, 2024

(54) METHOD AND APPARATUS FOR COORDINATING LOADING OF HAUL VEHICLES

(71) Applicant: Technological Resources Pty. Limited, Melbourne (AU)

(72) Inventor: Florian Andreas OPPOLZER, Melbourne (AU)

(21) Appl. No.: 18/686,000

(22) PCT Filed: Aug. 25, 2022
(86) PCT No.: PCT/AU2022/051017

§ 371 Date: Feb. 23, 2024

(30) Foreign Application Priority Data
Aug. 25, 2021 (AU) 2021221760
Aug. 25, 2021 (AU) 2021221812
Aug. 25, 2021 (AU) 2021221826
Aug. 25, 2021 (AU) 2021221840

(51) Int. Cl. E02F 9/20; E02F 9/26

(52) U.S. Cl. CPC E02F 9/2054; E02F 9/262; E02F 9/265

(57) ABSTRACT

A method is provided to coordinate loading of a material in an operational area by machine actors including haul trucks and loading vehicles. The method implements quick and efficient loading of trucks with the material in order to ensure that they are highly utilized. A vehicle coordination assembly is provided to establish data communications with vehicle sensing systems of the haul trucks and of the loading vehicles and determine load-ready haul trucks. For each load-ready haul truck, a loading task is assigned to two or more of the loading vehicles for loading of the load-ready haul truck. Each task specifies a respective safe operating space in which a loading vehicle is restricted to operating. The assigned loading vehicle with a safe operating space extending over a side of the haul truck can only perform a dumping operation to the haul truck at any one time.

### RELATED APPLICATIONS

The present application is related to the following complete Australian patent applications, each of which was filed on 25 Aug. 2021 and each of which was filed in the same name as the present applicant:
1) Australian complete patent application No. 2021221826 titled “Material categorisation and transportation systems and methods”.
2) Australian complete patent application No. 2021221812 titled “Methods and systems for mining”.
3) Australian complete patent application No. 2021221760 titled “Transporting a mined material”.
4) Australian complete patent application No. 2021221840, titled “Method and apparatus for coordinating loading of haul vehicles”.

The contents of each of the above-referenced applications 1)-4) is incorporated in full herein by way of cross-reference.

The present application is also related to the following co-pending International patent applications, each of which was filed on 25 Aug. 2022:
5) International patent application entitled “Material categorisation and transportation systems and methods”.
6) International patent application entitled “Methods and systems for mining”.
7) International patent application entitled “Transporting mined material”.
8) International patent application entitled “A Mining Operation”.

The contents of each of the above-referenced applications 5)-8) is incorporated in full herein by way of cross-reference.

### TECHNICAL FIELD

The present invention concerns methods and apparatus for loading of haul trucks and finds particular application in quarries and open cut mines where there is a need to rapidly and efficiently load haul trucks with material such as blasted rock.

### BACKGROUND ART

Any references to methods, apparatus or documents of the prior art are not to be taken as constituting any evidence or admission that they formed, or form part of the common general knowledge.

FIG. 1 stylistically depicts a blasted bench area 1 of an open cut mine. Subsequent to a blasting operation having taken place, material 3 from the blasting falls and must be hauled away to various stations for processing and ultimately transportation to customers. The stations may include various operational sites, such as a crusher site, a loading site, a dump site, a stockpile site and a shipping site. To that end, machine actors are provided in the blasted bench area 1 for loading and hauling the blasted material 3. For example, the machine actors include haul trucks 2-1, . . . , 2-1 (generally referred to as item “2”) and loading vehicles 4-1, . . . , 4-J (generally referred to as item “4”) for loading the haul trucks 2 with the blasted material 3. Other types of machine actors, such as digging and material handling machines may be present for example, dozers, mobile surge loaders, hoppers and mobile conveyor belts. Machine actors comprising different types of loading vehicles 4 may be provided such as the front-end loaders 4-1, 4-2, or as they are sometimes called “wheel loaders”, rope shovels 4-3, front shovels and hydraulic excavators 4-4.

The haul trucks 2 may comprise very large trucks, such as haul trucks 2-1 and 2-2, which are too large to be driven on public roads, and also trucks 2-3, 2-4, 2-I which are smaller and which may be safely driven on public roads.

One issue that arises in efficiently running an open cut mining operation is that of maximizing utilization of equipment. An operational area that is desirable to optimize is that of the transfer of material from the blasted bench into haul trucks by the loading vehicles. To that end a number of strategies have been adopted for efficiently operating loading vehicles to load haul trucks. For example, FIG. 1A depicts a double side loading method by which two unloaded trucks 4-1, 4-2 are loaded by one hydraulic excavator 6. Haul truck 4-1 is loaded on its left side and Haul truck 4-2 is loaded on its right side. The haul trucks 4-1, 4-2 enter the bench area 1 empty. The trucks then each follow the paths indicated by the arrows to positions “A” and “B” and then reverse back towards the blasted bench material 3 on opposite sides of hydraulic excavator 6 to positions “C” and “D” where they are loaded by the hydraulic excavator 6.

There is a need to be able to quickly and efficiently load trucks with material in order to ensure that they are highly utilized.

### SUMMARY OF THE INVENTION

In one aspect there is provided a method to coordinate loading of material in an operational area by machine actors, including haul trucks and loading vehicles, the method comprising:
operating a vehicle coordination assembly to
   establish data communications with vehicle sensing systems of the haul trucks and of the loading vehicles;
   with reference to the data communications, determine load-ready haul trucks being haul trucks that are ready to be loaded;
   for each load-ready haul truck, assign a loading task to two or more of the loading vehicles for loading of the load-ready haul truck, each task specifying a respective safe operating space in which a loading vehicle is restricted to operating; and
   set the safe operating space in respect of one of the assigned loading vehicles to extend from a region of the material in the operational area over a side of the load-ready haul truck, whilst setting each safe operating space in respect of other of the assigned loading vehicles to fall short of a side of the haul truck,
whereby only the assigned loading vehicle with a safe operating space extending over the side of the haul truck performs a dumping operation to the haul truck at any one time; and
   upon determining completion of the dumping operation, revising the safe operating spaces to allow a next loading vehicle to perform a dumping operation to the haul truck whilst preventing other loading vehicles from performing a dumping operation to the haul truck.

In an embodiment the method includes operating the vehicle coordination assembly to track all the machine actors.

In an embodiment the method includes operating the vehicle coordination assembly to facilitate collision avoidance whilst determining the respective safe operating space of each task by taking into account poses of all of the machine actors.

In an embodiment the loading tasks specify respective safe operating spaces that are non-overlapping at any given time to effect the collision avoidance.

In an embodiment the method includes operating the vehicle coordination assembly to send a move command to the haul truck upon determining that the haul truck has been fully loaded.

In an embodiment the method includes operating the vehicle coordination assembly to send a move command to an unloaded haul truck to bring the unloaded haul truck to a position for loading by the two or more loading vehicles.

In an embodiment the method includes storing dimensions of the haul trucks and of the loading vehicles in a data storage assembly of the vehicle coordination assembly.

In an embodiment the method includes operating the vehicle coordination assembly to determine the safe operating spaces with reference to the dimensions of the haul trucks and loading vehicles.

In an embodiment the loading vehicles comprise front-end loaders.

In an embodiment the loading vehicles comprise one or more different types of loading vehicle.

In an embodiment the method includes operating the vehicle coordination system to track the at least two loading vehicles to avoid collision of a bucket of the first loading vehicle with a bucket of the second loading vehicle during implementation of each loading task.

In an embodiment the vehicle sensing systems include LIDAR.

In an embodiment the vehicle sensing systems include radar.

In an embodiment the vehicle sensing systems include stereo vision cameras.

In an embodiment the vehicle sensing systems include joint encoders for ascertaining joint angles.

In an embodiment one or more of the loading vehicles are autonomous.

In an embodiment one or more of the haul trucks are autonomous.

In an embodiment the haul trucks include Right Sized Autonomous Trucks (RSATs).

In another aspect there is provided a system to coordinate loading of material in an operational area by machine actors including haul trucks and loading vehicles, the system comprising:
the haul trucks;
the loading vehicles for loading the haul trucks;
each haul truck and each loading vehicle having a vehicle sensing assembly in communication with a respective vehicle communication system, the vehicle communication system arranged to transmit pose data of the haul trucks and of the loading vehicles;
a vehicle coordination assembly in communication with said vehicle communication systems of the haul trucks and of the loading vehicles via a data network, the vehicle coordination assembly configured to:
   establish data communications with vehicle sensing systems of the haul trucks and of the loading vehicles;
   with reference to the data communications, determine load-ready haul trucks being haul trucks that are ready to be loaded;
   for each load-ready haul truck, assign a loading task to two or more of the loading vehicles for loading of the load-ready haul truck, each task specifying a respective safe operating space in which a loading vehicle is restricted to operating; and
   set the safe operating space in respect of one of the assigned loading vehicles to extend from a region of the material in the operational area over a side of the haul truck, whilst setting each safe operating space in respect of other of the assigned loading vehicles to fall short of a side of the haul truck,
whereby only the assigned loading truck with a safe operating space extending over the side of the haul truck performs a dumping operation to the haul truck at any one time; and
   upon determining completion of the dumping operation, revising the safe operating spaces to allow a next loading vehicle to perform a dumping operation to the haul truck whilst preventing other loading vehicles from performing a dumping operation to the haul truck.

In an embodiment the vehicle coordination assembly is configured to assign loading tasks specifying respective safe operating spaces that are non-overlapping at any given time to effect collision avoidance of the machine actors.

In an embodiment the vehicle coordination assembly is configured to send a move command to a haul truck upon determining that the haul truck has been fully loaded and/or to send a move command to an unloaded haul truck to bring the unloaded haul truck to a position for loading by the two or more loading vehicles.

In an embodiment the system includes a data storage assembly storing dimensions of the haul trucks and the loading vehicles.

In an embodiment the vehicle coordination assembly is configured to determine the safe operating spaces with reference to the dimensions of the haul trucks and loading vehicles.

In an embodiment the at least two loading vehicles comprise front end loaders and the vehicle coordination system is configured to track the at least two loading vehicles to avoid collision of a bucket of the first loading vehicle with a bucket of the second loading vehicle during implementation of each loading task.

In a further aspect there is provided a method to load a haul truck with material by operating first and second loading vehicles, the method comprising:
determining a position of the haul truck in a state of readiness for loading;
for each of the first and second loading vehicles, assigning first and second loading tasks to transfer material into the haul truck
the first and second loading tasks progressing from loading buckets of the first and second loading vehicles to dumping loads from the buckets into the haul vehicle wherein the first and second loading tasks specify respective safe operating spaces for the first and second vehicles to cause the first and second loading vehicles to dump from opposite sides of the haul vehicle at separate times.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts machine actors, such as autonomous loading vehicles and autonomous haul trucks, in operation at a blasted bench of an open cut mine.

FIG. 1A is a diagram depicting a prior art double side loading method.

FIGS. 2 to 4 are side views of a loading vehicle in the form of a front-end loader in different operational configurations.

FIG. 5 is a block diagram of a vehicle control and sensing assembly of the machine actors.

FIG. 6 depicts a system comprising a vehicle coordination assembly, data network and loading vehicles and haul trucks in operation at a blasted bench.

FIG. 7 is a block diagram of the vehicle communications assembly.

FIG. 8 is a detail top plan view of the loading vehicles and haul trucks in operation at the blasted bench.

FIG. 9 is a diagram depicting first and second loading vehicles implementing loading tasks assigned to them from the vehicle coordination assembly to load a load-ready haul truck from opposed sides thereof.

FIG. 10 is a diagram depicting safe operation boundary boxes for the first and second loading vehicles for collision avoidance.

### DETAILED DESCRIPTION OF PREFERRED EMBODIMENTS

Right Sized Autonomous Trucks or RSATs are conventionally sized, autonomous, and preferably electric trucks. The term “conventionally sized” as used herein refers to trucks that are around, or within, the conventional size range of trucks that can travel on public roads. Autonomous vehicles, including autonomous mining vehicles, are known and are manufactured by a variety of companies including Scania, Volvo and Autonomous Systems, Incorporated.

Conventionally sized trucks are more maneuverable than large open mine trucks so that their turning and spotting time is less. Conventionally sized trucks can be located at precise locations on a blasted mining bench for example so that mining operations, which may be infeasible or impossible with standard larger sized open mine trucks, become possible. For example, conventionally sized trucks can be operated on 5-meter benches compared to 10-meter benches when using standard sized open mine trucks and using conventionally sized trucks can result in an improved resolution of ore stockpiles.

Another advantage of using conventionally sized trucks is that because of their smaller size, they can be efficiently loaded with machines such as front-end loaders, rather than larger machines such as excavators. Front-end loaders can be easier to move from place to place, particularly on smaller benches.

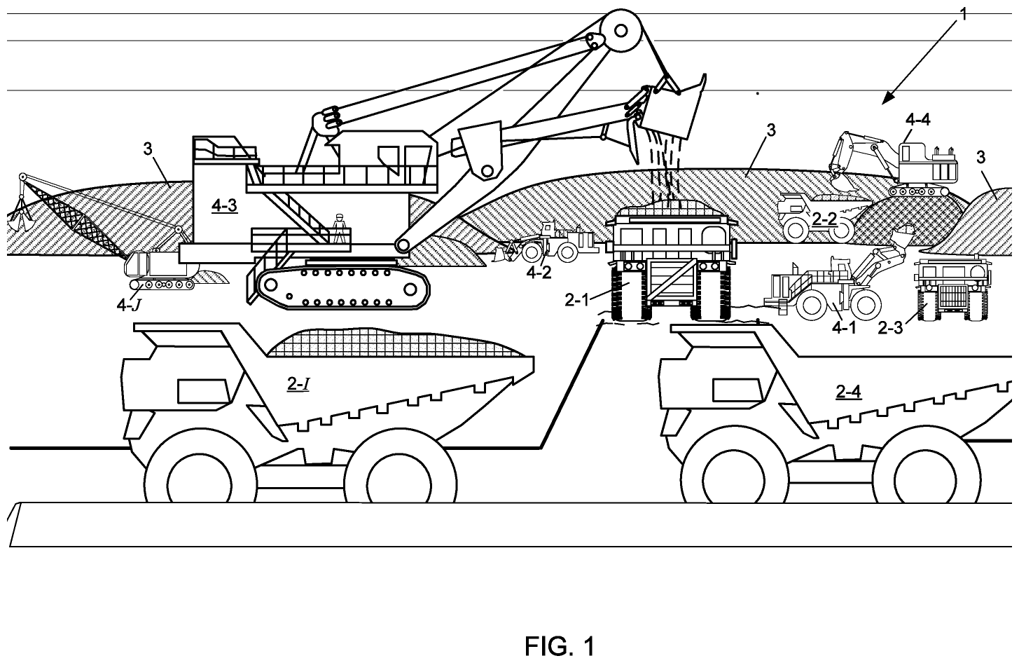

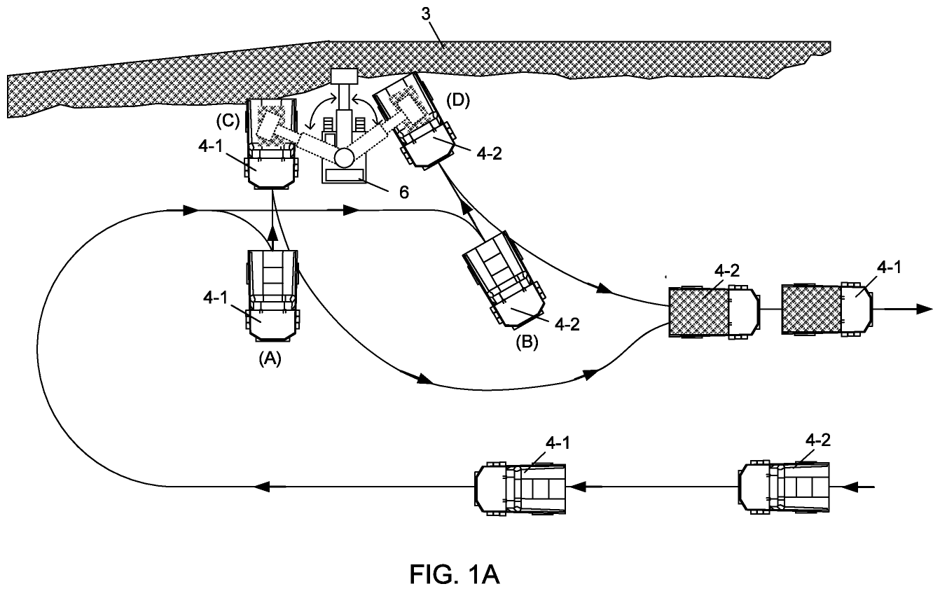

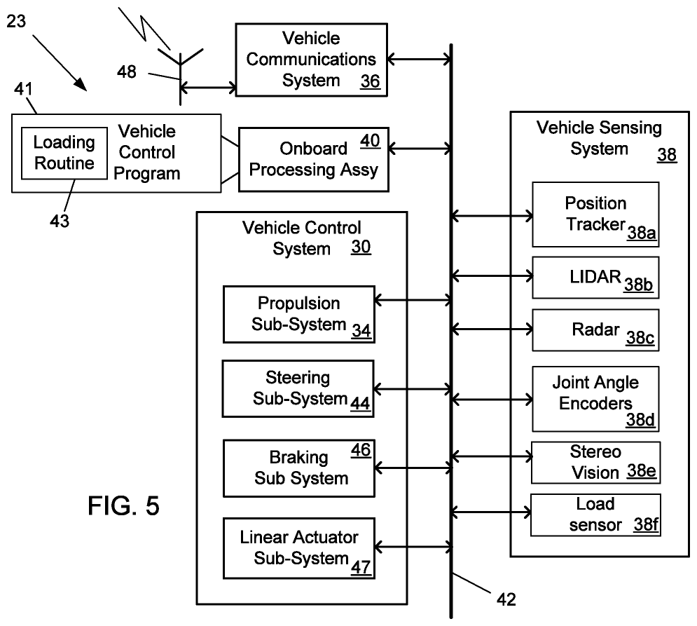

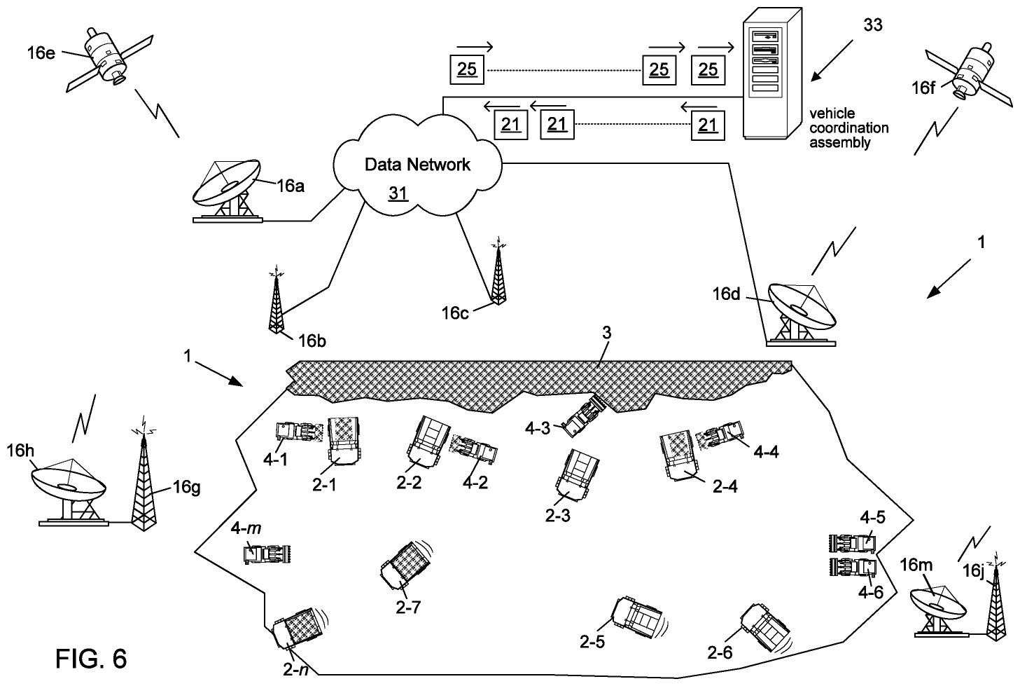

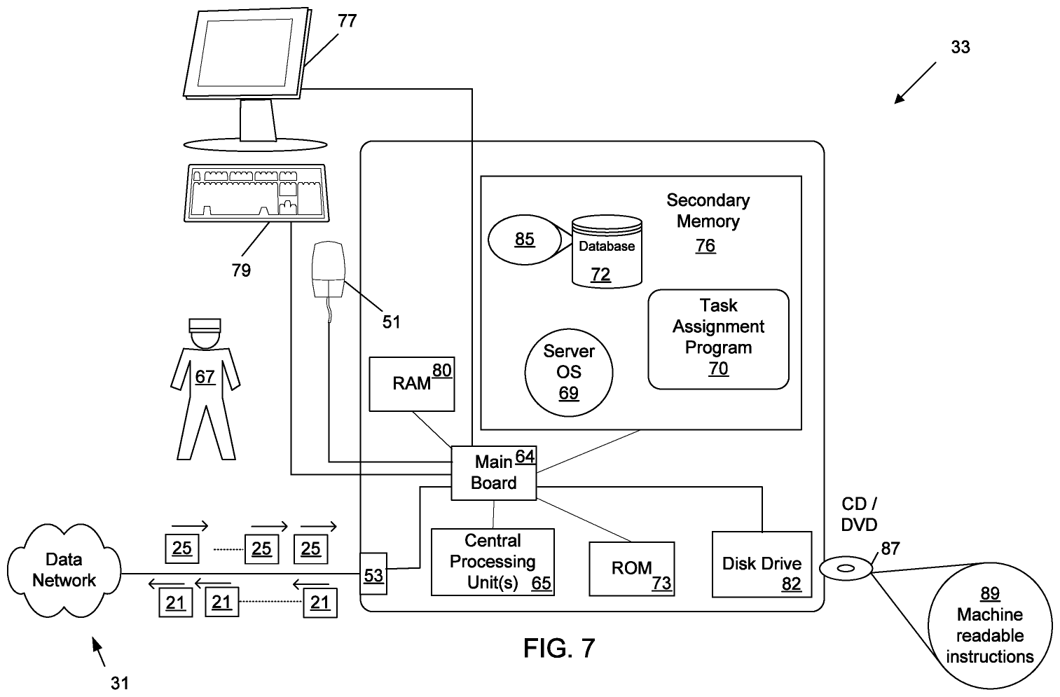

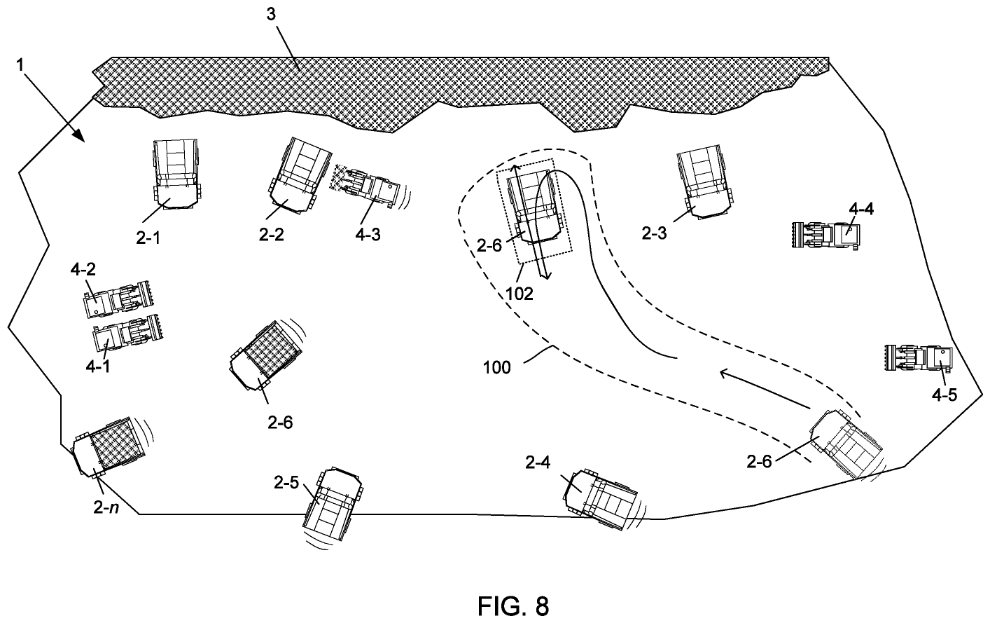

In order to provide an overview, the present disclosure relates to a method to load a number of haul trucks such as haul trucks 2-1, . . . , 2-5 as shown in FIG. 8, with material, for example material 3, in an operational area such as a blasted bench of an open cut mine. The haul trucks may include conventionally sized trucks, such as RSATs. In an embodiment the method involves using a plurality of loading vehicles, such as front-end loaders 4-1, . . . , 4-5, and other types of loading vehicles as well. Examples of a loading vehicle in the form of a front-end loader appear in FIGS. 1, 2 to 4, 6 and 8 to 10. During performance of the method a vehicle coordination assembly, such as vehicle coordination assembly 33 (FIGS. 6 and 7), is operated to establish data communications with vehicle sensing systems, illustrated as item 38 of FIG. 5, of the haul trucks and of the loading vehicles via a data network 31, which is shown in FIGS. 6 and 7.

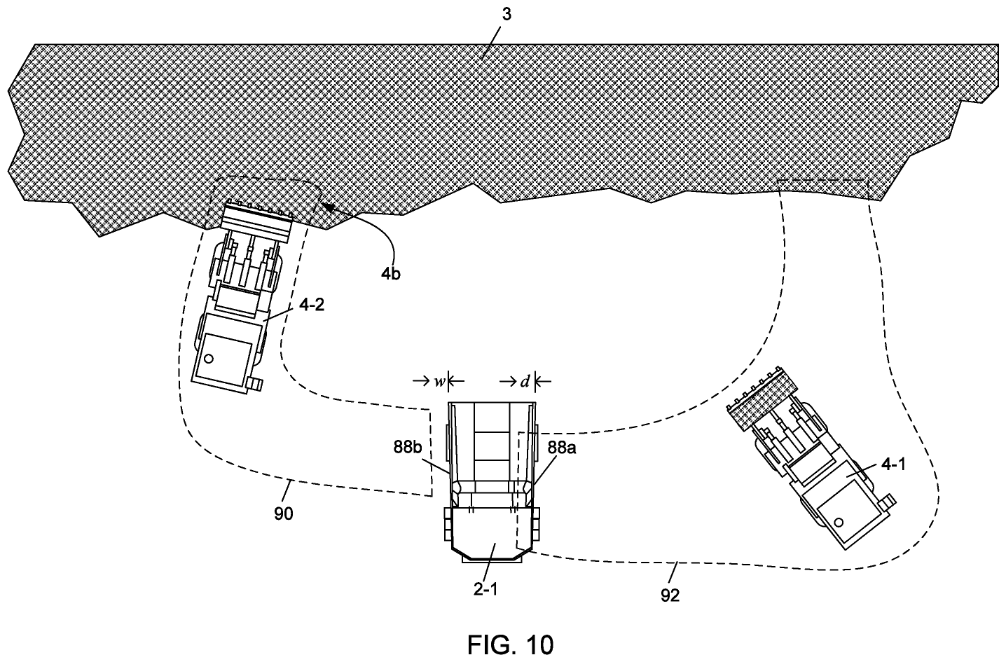

The method involves operating the vehicle coordination assembly 33 to determine load-ready haul trucks. For example, FIG. 10 shows an empty and stationary haul truck 2-1 that is adjacent blasted bench material 3 and thus is ready for loading and so may be referred to as a “load-ready haul truck”. Typically the vehicle coordination assembly 33 determines that a haul truck is load-ready simply by receiving a message to that effect from the haul truck via the data network 31. The pose of the haul truck 2-1, i.e., its position, orientation, and state of readiness to be loaded, i.e. a load-ready haul truck, as shown in FIG. 10 is ascertained by haul truck 2-1's vehicle sensing system 38 (FIG. 5) and sent to the vehicle coordination assembly 33 using haul truck 2-1's vehicle communications system 36. The pose information is sent via data network 31 and comprises pose data messages 25 (FIGS. 6 and 7), which emanates from the vehicle sensing system 38. Consequently, the vehicle coordination assembly 33 is able to track the pose of each of the haul trucks and of each of the loading vehicles and indeed of all other similarly equipped machine actors in the operational area.

The vehicle coordination assembly 33, configured by task assignment program 70 (FIG. 7) selects at least two loading vehicles, for example front-end loaders 4-1, 4-2 to load the load-ready haul trucks (e.g. truck 2-1 of FIG. 8). The selection vehicle coordination assembly 33 then assigns a loading task to two or more of the loading vehicles to load the load-ready haul truck.

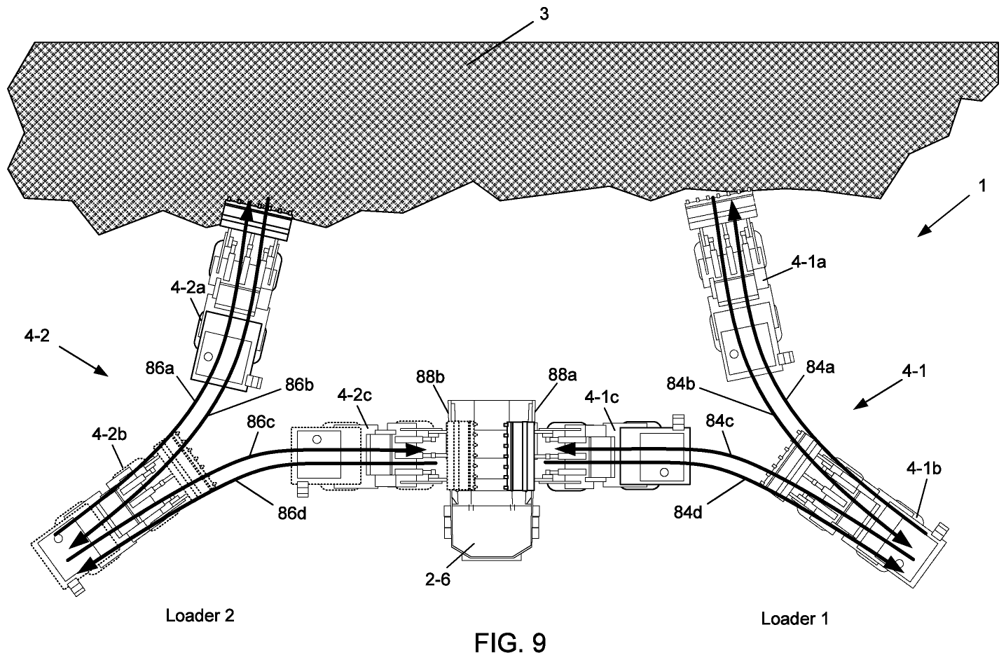

Each task specifies a respective safe operating space for the loader to which the task has been assigned. The safe operating space is a space in which a loading vehicle is restricted to operating. For example, safe operating spaces 90 and 92 for loading vehicles 4-2 and 4-1 respectively are illustrated in FIG. 10. Vehicle coordination assembly 33 allocates the safe operating spaces the loading vehicles for them to operate therein without risk of collision with other loaders. FIG. 9 illustrates possible paths that the loading vehicles may follow when implementing their assigned loading tasks with initial safe operating spaces 90 and 92 as shown in FIG. 10.

Vehicle coordination assembly 33 sets the safe operating space in respect of one of the assigned loading vehicles to extend from a region of the material in the operational area over a side of the haul truck, whilst setting each safe operating space in respect of other of the assigned loading vehicles to fall short of a side of the haul truck. For example, referring again to FIG. 10, it can be seen that the safe operating space 92 allocated to loading vehicle 4-1 extends a distance d over a side 88a of haul truck 2-1 whereas the operating space 90 allocated to loading vehicle 4-2 falls short of the opposite side 88b by a distance w. Consequently, only the assigned loading vehicle 4-1 with the safe operating space 92 extending over the side 88a of the haul truck 2-1 is able to perform a dumping operation to the haul truck 2-1 at the time illustrated in FIG. 10. Loading vehicle 4-2 is able to fill its bucket at a region 4b of material 3, which is located within its present safe operating space 90, but cannot proceed to dump the material over side 88b into haul truck 2-1 while its safe operating space falls short of side 88b of haul truck 2-1.

Upon determining completion of the dumping operation by loading vehicle 4-1, the vehicle coordination assembly, revises the safe operating spaces 90 and 92 to allow a next loading vehicle, e.g. vehicle 4-2 to perform a dumping operation to the haul truck 2-1 whilst preventing other loading vehicles, for example loading vehicle 4-1 from performing a further dumping operation over side 88a and in to the haul truck 2-1.

The vehicle coordination assembly 33 transmits the respective loading tasks that have been assigned to the loading vehicles via data network 31 in a task assignment message 21 (FIGS. 6 and 7).

Upon receiving the task assignment message each loading vehicle implements the loading task with their onboard processing assembly 40 (FIG. 5) configured by vehicle control program 41. Processing assembly 40 applies the task assignment parameters to a material loading routine 43 stored in its onboard vehicle control program 41. The material loading routine as executed by onboard processing assembly 40 commands the vehicle control system 30 to navigate to the material to be loaded, within the safe operating space, load the loading vehicle's bucket and if allowed by the current setting of its safe operating space, dump the material into the bucket.

Now that an overview has been provided, further details of a method, and system according to one or more preferred embodiments will be discussed.

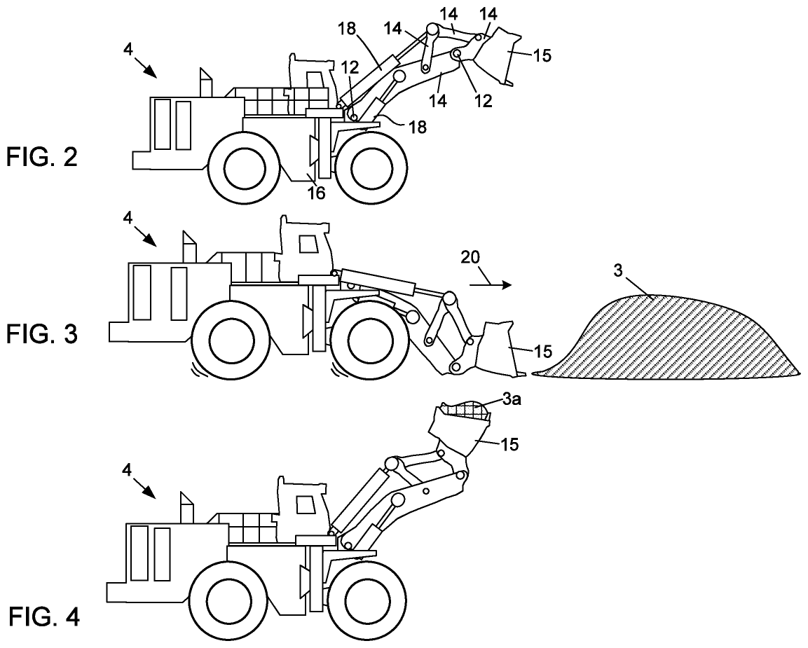

With reference to FIGS. 2 to 4, a loading vehicle such as front-end loader 4-1 is fitted with a bucket 15 which is supported by a linkage of rigid members 14 interconnected by joints 12 to a chassis 16 of the front-end loader 4-1. By operating hydraulic actuators 18, angles of the members 14 at joints 12 are manipulated to raise and lower the bucket 15 and consequently by driving the front-end loader 4-1 forward, as indicated by arrow into material 3 the bucket 15 can be raised with loaded with material 3a as shown in 20 FIG. 4 and then driven to a haul truck where the load 3a is deposited.

FIG. 5 is a block diagram of a vehicle control and sensing system 23 of the haul trucks and loading vehicles in an exemplary embodiment. Systems similar the vehicle control and sensing system 23 are known in the prior art and provided by one or more of the manufactures that have been mentioned in the Background section of this specification. The vehicle control and sensing system 23 includes a data bus 42 which facilitates electronic data communication between onboard processing assembly 40 which executes instructions comprising a vehicle control program 41 and thus is configured to coordinate interactions between:
Vehicle control system 30 sub-systems, namely:
   Propulsion Sub-System 34,
   Steering Sub-System 44,
   Braking Sub-System 46 and
   Linear Actuator Sub-System 47; and
Vehicle sensing system 38 assemblies, namely:
   Position Tracker Assembly 38a,
   LIDAR Assembly 38b,
   Radar Assembly 38c,
   Joint Angle Encoders Assembly 38d,
   Stereo Vision Assembly 38e, and
   Load Sensor 38f.

Vehicle control system 30 includes sub-systems 34-47 which, under control of the onboard processing assembly 40 enable a vehicle, such as a front-end loader to operate autonomously. In particular, the vehicle control program includes instructions for the onboard processing assembly 40 to implement a task assigned to it. Where the vehicle comprises a haul truck the task may be to move to a destination and operate its tray to unload. Where the vehicle comprises a loading vehicle the onboard processing assembly can implement a task for the vehicle to navigate to blasted material and to navigate to the haul truck for dumping, by taking into account data from the vehicle sensing system 38 and processing that data to generate commands for the various sub-systems of the vehicle control system 30.

As illustrated in FIG. 5, Vehicle control and sensing system 23 includes a vehicle sensing system 38 which in turn includes a number of assemblies 38a-38f for determining the vehicle's pose, which will typically comprise data such as the vehicle's position, speed, direction, proximity to other vehicles, orientation and joint angles.

Position tracker 38a may comprise a Global Positioning System (GPS) receiver which is configured to generate information about at least the position of the vehicle at each of a series of times, for example five second intervals. The position tracker may also be configured to triangulate a position estimate from terrestrial transmitters such as wireless transceivers 16a, 16b shown in FIG. 6, which are part of data network 31. The position tracker 32 may also include gyroscopes, accelerometers and/or other apparatus that can also be used to generate position signals indicating the location of the vehicle to which it is fitted within the mine environment. The position tracker 38a is able to ascertain at least the vehicle's position at progressive times as it travels through the area. Depending on the resolution of the data that the tracker provides to the vehicle communications system 36, it is possible to determine speed direction and orientation data that is transmitted via vehicle communications system 36 for logging and processing by another processing assembly such as vehicle coordination assembly 33, shown in FIG. 6. In the presently described exemplary embodiment, the vehicle tracking system 38 includes load sensors for gauging the weight of the load being hauled so that it is possible to determine if a haul truck tray or bucket of a loading vehicle is laden or empty. Vehicle tracking system 38 also includes LIDAR sensor 38b, radar sensor 38c and stereo vision sensors 38e for estimating proximity to obstacles and for assisting in collision avoidance and loading and unloading of material. Joint angle encoders 38d are also provided in the vehicle tracking system to generate signals indicating the angle of various joints including steering angle, bucket angle, and loader arm angles.

Vehicle communications system 36 which is coupled to an antenna 48 for transmitting radio frequency data communications to the data network 31, of which terrestrial receivers 16a, 16b (FIG. 6) are part. The vehicle communication system 36 receives messages and commands via the data network 31 from vehicle coordination assembly 33. For example, where the vehicle control and tracking system 23 is incorporated into a loading vehicle, such as a front-end loader, the vehicle communication system 36 will receive task assignment messages 21 for implementing loading of haul trucks. The data network 31 includes a collection of wireless data transceivers 16a, . . . , 16m including satellite and terrestrial transceivers suitable for implementing wireless communication protocols such as WiFi, WiMax, GPRS, EDGE or equivalent terrestrial and satellite wireless data communications. It will be appreciated that these network architectures are provided as examples only and thus are not limiting.

Referring now to FIG. 7, a vehicle coordination assembly 33 is depicted according to the presently described exemplary embodiment of the invention.

Vehicle coordination assembly 33 acquires pose data for each of the machine actors in the operational area, including the haul trucks and the loading vehicles, via a stream of pose data messages 25 from the vehicles 2-1 . . . , 2-I via the data network 31 which provide location estimates for the vehicles within a defined coordinate frame The pose data messages contain information such as a position coordinate, time at which the position current orientation, current posture of components such as trays, arms and buckets, and information about when the message was generated from which machine actor.

The pose data messages may comprise, or be based, on data from any/all of positioning systems such as US GPS, Russian GLONASS, EU's Galileo positioning system, China's Beidou positioning system or local positioning systems such as India's NavIC and Japan's QZSS.

It will be realized that Global Navigation Satellite Systems (GNSS) such as the US owned Global Positioning System (GPS) is one method of obtaining localization data, other methods such as cell-tower-triangulation based localization might also be used as an alternative or in addition to GNSS.

As will be explained, the vehicle coordination assembly 33 is configured to process the pose data messages 25 and determine task assignments 21, which are transmitted across the data network 33, to the loading vehicles 4 to effect transfer of material 3 to the haul trucks 2.

The vehicle coordination assembly 33 is provided in the form of a specially configured processing assembly that is in data communication with vehicle tracking and control systems 23 of the haul trucks and the loading vehicles via data network 31.

The embodiment of the vehicle coordination assembly 33 that will be described is a preferred implementation but not the only possible implementation. In other embodiments the vehicle coordination assembly 33 may be implemented as a distributed or decentralized assembly. For example, in other embodiments the vehicle coordination assembly 33 may be implemented as a number of servers that each cooperate with each other to undertake different steps of the method that will be described.

Vehicle coordination assembly 33 includes a main board 64 which includes circuitry for powering and interfacing to a processing assembly comprising one or more onboard microprocessors or “CPUs” 65.

The main board 64 acts as an interface between CPUs 65 and an electronic memory assembly in the form of a secondary memory 76. The secondary memory 76 typically comprises one or more magnetic or solid-state drives. The secondary memory 76 stores instructions for an operating system 69. The main board 64 also communicates with random access memory (RAM) 80 and read only memory (ROM) 73. The ROM 73 typically stores instructions for a startup routine, such as a Basic Input Output System (BIOS) or Unified Extensible Firmware Interface (UEFI) which CPUs 65 access upon start up and which preps the CPUs 65 for loading of the operating system 69.

The main board 64 also includes an integrated graphics adapter for driving display 77. The main board 64 accesses a data communications assembly in the form of adaptor 53, for example a LAN adaptor or a modem, that places the vehicle coordination assembly 33 in data communication with data network 31.

An operator 67 of vehicle coordination assembly 33 may interface with it by means of a human-machine-interface in the form of keyboard 79, mouse 51 and display 77 but more usually the vehicle coordination assembly will not have a hardware human-machine-interface but rather administrator 67 will log in remotely. For example, by means of a remote terminal application that is part of Server OS 69.

Subsequent to the BIOS or UEFI booting up the server the operator 67 may operate the operating system 69 to load the Task assignment program 70. The Task assignment program 70 may be provided as tangible, non-transitory, machine-readable instructions 89 borne upon a computer readable media such as optical disk 87 for reading by disk drive 82. Alternatively, Task assignment program 70 may also be downloaded via port 53.

As mentioned, the secondary memory 76, is typically implemented by a magnetic or solid-state data drive and stores the operating system 69, for example Microsoft Windows Server, and Linux Ubuntu Server are two examples of such an operating system.

The secondary storage 76 also includes the Task assignment program 70, which configures the vehicle coordination assembly 33 to assign tasks for the loading vehicles to effect loading of material into the haul trucks with collision avoidance. The Task assignment program includes instructions for the vehicle coordination assembly 33 to revise the safe operating spaces for the loading vehicles, which has been previously mentioned, prevents or allows particular loading vehicles to dump material into a load-ready haul truck whilst preventing simultaneous dumping of loading vehicle buckets into the haul truck and thus a potential collision.

During operation of the vehicle coordination assembly 33 the one or more CPUs 65 load the operating system 69 and then load the Task assignment program 70.

It will be realized that the illustrated arrangement of the vehicle coordination assembly 33 is simply one example of its arrangement. Other suitable arrangements are also possible, for example the program 70 could be executed by the vehicle coordination assembly 33 in the form of a virtual machine in a cloud computing environment to thereby implement a specially configured vehicle coordination assembly.

Methods that are implemented by the vehicle coordination assembly 33 under control of the Task assignment program 70 in order to process the vehicle pose data messages 25 to generate the assignment messages 21 will be described. These methods are coded as machine readable instructions, which comprise the Task assignment program 70, for execution by CPUs 65.

To recap, machine actors in an open cut mining bench area include haul trucks, which need to be loaded and loading vehicles for loading the haul trucks. The machine actors are autonomous, and they are equipped with control systems and sensing systems. The sensing systems create a sequence of pose data messages 25. The pose data messages specify the pose of the machine actors, e.g. haul trucks 2 and loading vehicles 4 and include information such as the orientation, position of the vehicle and also information such as the extension, height and angle of booms, arms and buckets of the machine actors.

A Vehicle coordination assembly 33 is provided which facilitates coordination of the loading vehicles 4 for loading the haul trucks 2 via a data network 31.

The central vehicle coordination assembly receives the pose data messages 25 from each of the machine actors.

Upon a haul truck, for example truck 2-6, initially shown in dotted line in FIG. 8, entering the operational area 1, the Vehicle coordination assembly 33 searches for an available loading bay, which may be a pre-designated parking bay or may simply be an area that is free and in proximity to material (such as a pile of blasted bench material) in the operational area to be loaded into the haul truck. The operational area is typically an area on a bench of an open cut mine, adjacent a pile of blasted material. For example, in FIG. 6 vehicle 2-6, upon entering area 1 is allocated a corridor 100 which is a safe operating space that is sufficiently large for vehicle 2-6 to turn around in and assume a load ready pose in loading bay 102.

The vehicle coordination assembly 33 allocates a corridor to a haul truck for it to travel from its current position to the available loading bay taking into account the pose and trajectories of other machine actors in the operational area in order to avoid collisions as the haul truck moves along the corridor. It should be realised that in the context of a bench of an open cut mine, “corridors” are generally not roads. Corridors are transitionary and only exist while a vehicle is transiting the corridor. As a vehicle transits along a corridor, the already transited portion of the corridor “disappears” behind it. A corridor is not a semi-permanent construct, for example one that exists even when the vehicle is not transiting along it.

As the haul truck moves to the available loading bay other vehicles moving along intersecting corridors may assume higher priority so that the Vehicle coordination assembly 33 may send a pause, slow-down, or speed-up command to the haul truck or may update the path taken by the provisional corridor for collision avoidance.

The haul truck 2-6 parks at the loading bay 102 with a load-ready pose, i.e., a position and orientation for loading and a configuration for loading, such as having its tray down and ready to accept material. For example, typically the haul truck will assume a pose that places a rear of the truck toward the pile of material 3. The Vehicle coordination assembly 33 determines that the haul truck, once at the loading bay, is available for loading. That may be inferred from the pose data messages or, more preferably it is done by the haul truck sending a “load-ready” message in its pose data messages 25 to the Vehicle coordination assembly 33.

Referring now to FIG. 9, in one example, with respect to load-ready haul truck 2-6 the Vehicle coordination assembly 33 selects two or more loading vehicles, being loading vehicles 4-2 and 4-1 that it assigns to load each load-ready haul truck, such as haul truck 2-6 in the operational area 1. In FIG. 9, loading vehicle 4-2 is shown at its current position 4-2a in solid line and at other positions 4-2b and 4-2c, during performance of its loading task, in dotted line. Similarly, loading vehicle 4-1 is shown at its current position 4-1c in sold line and at other positions 4-1b, 4-1a, during performance of its loading task, in dotted line.

Task assignment program 70 (FIG. 7) may include instructions configuring the Vehicle coordination assembly 33 to select the two or more loading vehicles, (4-1, 4-2) to load each of the load-ready haul trucks, simply on the basis of distance of the loading vehicles to the haul trucks but more preferably, taking into account a range of factors such as proximity, overall material flow (where to dig from and how to advance the dig face), material blending (e.g. some trucks may have waste other may have ore), etc. Overall optimisations take all into account to produce best dig sequence. Furthermore, other considerations include what types of loading vehicles are available/free and what combination of loading vehicles can be simultaneously assigned to the loading of a truck. For example, if two excavators and two shovels are free, one excavator and one shovel may be assigned to a truck rather than 2 excavators, regardless of which vehicle is closest.

Once the Vehicle coordination assembly 33 has selected the two or more loading vehicles it transmits respective bucket dumping task assignments to them.

The task assignments for each assigned loading vehicle will typically include:

1. The position and loading side of the haul truck.

2. A safe operating area in the form of a corridor in which the loading vehicle can operate the corridor allows the loading vehicle to move from a region of the pile to the loading side of the haul truck.

3. An operational time window, being an expected time frame for the loading vehicle bucket dumping operation to occur.

The Vehicle coordination assembly 33 continues to monitor the pose of each of the loading vehicles (and all other machine actors in the operational area) for collision avoidance.

The task assignments are on a loading vehicle bucket load-by-load basis. By “load-by-load basis” it is meant that the Vehicle coordination assembly 33 issues a task to a loading vehicle each time it receives a message from the loading vehicle confirming that the loading vehicle has completed a task, which is a task of dumping a bucket load of material into its assigned haul truck. Accordingly, the loading vehicles may initially start to load a first haul truck and some of them may continue to load that haul truck until it is fully loaded whilst others may be assigned to other haul trucks prior to complete loading of the initially assigned haul truck occurring.

Therefore, it will be realised that the Vehicle coordination assembly 33 does not necessarily assign task assignments to all the assigned loading vehicles at approximately the same time. If there happens to be two loading vehicles that need loading assignments at the same time, then they may both receive their task assignments at approximately the same time. However, most of the time, task assignments will be assigned to loading vehicles at different times, specifically when a loading vehicle needs one.

The Vehicle coordination assembly 33 may also issue task assignments to a loading vehicle midway through a task. For example, a loading vehicle that was originally tasked with dumping its current load into truck A may be dynamically assigned to dump its load into truck B even though its already on its way to truck A.

An example will now be described. In the following T1, T2, etc correspond to task assignments 25 generated by the vehicle coordination assembly 33:

### Example

Vehicle coordination assembly 33 sends task T1 to Loader 1 and task T2 to Loader 2

T1: Loader 1, Load haul truck HT1 from side S1. Your corridor extends from the area of the pile (e.g. area P_x1y1), from which you are to load your bucket and comprises corridor C1. When corridor C1 extends over the side S1 of HT1 then dump your bucket into HT1.

T2: Loader 2, your task is to load haul truck HT1 from side S2. Your corridor extends from the area of the pile (e.g. area P_x2y2), from which you are to load your bucket, and comprises corridor C2. When corridor C2 extends over the side S2 of HT1 then dump your bucket into HT1.

Initially Vehicle coordination assembly 33 sets corridor C1 so that it extends over the side of S1 and sets corridor C2 so that it does not extend over the side S2. Consequently, both Loader 1 and Loader 2 proceed to load their buckets from the areas of the pile, P_x1y1 and P_x2y2 that their corridor extends to, but, initially only Loader 1 can dump into haul truck HT1 because its corridor C1 extends over the side of S1 of the haul truck HT1 whereas C2 does not extend over side S2 so that Loader 2 recognises that it cannot reach HT1 for its bucket dumping operation.

Loader 1 dumps into haul truck HT1 and sends a message confirming that it has done so and as part of its onboard dumping automation procedure it also reverses from the side S1 of HT1.

In response to receiving the message from Loader 1 the Vehicle coordination assembly 33 retracts corridor C1, or makes it cease to exist, so that it no longer extends over the side S1 of HT1. At about the same time the Vehicle coordination assembly 33 extends corridor C2 over the side S2 of HT1. In response to the extension of corridor C2, Loader 2 dumps its bucket load over side S2 and into HT1, reverses from HT1 and sends a message confirming that it has dumped its bucket load into HT1 back to the Vehicle coordination assembly 33.

The Vehicle coordination assembly 33 now retracts corridor 2 from HT1, or makes it cease to exist, so that Loader 2 cannot reach HT1 and extends corridor 1 or creates a new corridor extending over side S1 of HT1. Alternatively, since Loader 1 has previously already completed its dump it is more than likely that Loader 1 is on its way to pick up another load when Loader 2 has just completed its dump. Accordingly, the Vehicle coordination assembly 33 will find it more efficient to assign to Loader 1 a corridor to get it to its new load to pick up, i.e. is to fill its bucket with material rather than extend Loader 1's old corridor to again extend over the side S1 of HT1.

The Vehicle coordination assembly 33 now sends further tasks, for example it may send further tasks that simply repeat T1 and T2 until it receives a “loading completed” message from the haul truck HT1 stating that HT1 has a full payload. When the Vehicle coordination assembly 33 receives a loading completed message it updates its database to indicate that Loader 1 and Loader 2 are free for new assignments. Depending on the pose messages that HT1 sends to Vehicle coordination assembly 33, Vehicle coordination assembly 33 may be able to determine that there is only one more bucket load to be dumped into HT1 before it will reach loading completed status. In that case it may assign a new assignment to Loader 1 before Loader 2 has completed its final bucket dump into HT1.

The tasks will typically also include a timeframe for completion. If a task is not completed within the allocated timeframe then the Vehicle coordination assembly 33 may extend the timeframe, and potentially also the timeframe of other loading vehicles that are assigned to load the same haul truck. The Vehicle coordination assembly 33 may request diagnostic information from the loading vehicle and, if it appears that there is a functional impairment of the loading vehicle, end its task assignment and possibly flag the loading vehicle for maintenance.

Alternatively, Vehicle coordination assembly 33 may determine for operational reasons that the assignment of loaders should change for one or both of Loader 1 and Loader 2 after they have completed their first bucket dump into HT1. For example, the Vehicle coordination assembly 33 may determine that another haul truck, HT2, needs to receive a bucket dump of material from location P_x3y3 of the pile dumped into it. That may occur to bring the final load in HT2 to a desired blend for example. In that event Vehicle coordination assembly 33 may assign Loader 1 to HT2 and assign another loading vehicle, Loader 3 to HT1. The tasks in that case may then be as follows:

T3: Loader 1, Load haul truck HT2 from side S2. Your corridor extends from the area of the pile P_x3y3 from which you are to load your bucket and comprises corridor C3. When corridor C3 extends over the side S2 of HT2, dump your bucket into HT1.

T4: Loader 2, load haul truck HT1 from side S2. Your corridor extends from the area of the pile (e.g. area P_x2y2) from which you are to load your bucket and comprises corridor C2. When corridor C2 extends over the side S2 of HT1, dump your bucket into HT1.

As before, the Vehicle coordination assembly 33 retracts and extends the corridors or cancels and creates corridors so that corridors to each side of a haul truck to be loaded do not extend over the opposed sides of the haul truck at the same time so that there is no risk of the buckets of the respective loading vehicles colliding.

It should be recalled that corridors are preferably transitory so that new corridors are constantly generated every time any vehicle has to move somewhere new, even if that ‘new’ destination is back where it just came from. Consequently, while dozer 4-1 of FIG. 10 is picking up more material from the pile 3, it is possible that another dozer “4-x” (not shown) could dump its load into truck 2-1 from the right-hand side depending on the task allocations.

For example, with reference to FIG. 10:

1. Dozer 4-1 has picked up a load from the pile 3

2. Dozer 4-1 is allocated a corridor allowing it to travel safely from its current position to side S1 88a of truck 2-1

3. As dozer 4-1 transits along the corridor, the already transited portions of the corridor behind dozer 4-1 ‘disappear’.

4. As dozer 4-1 nears side S1 88a a check is done to see if any other loading vehicle is currently dumping a load into truck 2-1. That is, a check is done to see if there exist any corridors that overlap any one of the sides S1 88a, S2 88b of the truck 2-1.

5. If there are no corridors overlapping any of sides S1 88a and S2 88b, then dozer 4-1's corridor is extended to overlap side S1 88a.

6. Dozer 4-1 dumps its load over side S1 88a.

7. Dozer 4-1 has thus completed 1 cycle/route and asks for (or perhaps is already provided with) its next task instruction.

8. A new corridor is generated for dozer 4-1 to allow it to fulfil its next task instruction; which may be to simply go back to the pile 3 along the route it just took.

An advantage of the loading system that has been described is that while it allows two, or more, loading vehicles to be assigned to load a common haul truck at the same time so that they can simultaneously proceed with digging the pile to fill their buckets and travelling to the pile and from the pile towards the haul truck, it avoids simultaneous dumping into the haul truck at the same time to avoid collision, such as a clash of the loading vehicles' buckets.

The system coordinates loading tasks of two or more loading vehicles with a view to optimizing maximum loading throughput to one or more haul trucks. Without a coordination assembly, such as the Vehicle coordination assembly 33 this assigning of two loaders to one truck would not be possible without a high risk of collision because a loading vehicle's sensing system cannot readily see the other loader nor coordinate with it effectively when they are loading on opposite sides of the same vehicle. The Vehicle coordination assembly 33 provides for synchronising the loading of two or more loading units, by coordinating extension and retraction of the respective safe operational corridors for each loading vehicle on opposite sides of the haul truck, to significantly increase overall dig rate.

During the transfer and loading operations, the vehicle coordination assembly may effect collision avoidance whilst determining the task assignments to prevent interference of the each of the first and second loading vehicles with each other. Alternatively, or additionally each of the machine actors in the region of the blasted bench, including the loading vehicles 4-1, 4-2 and haul truck 2-1 will also preferably implement obstacle and collision avoidance using their onboard processors 40 configured by instructions comprising the vehicle control program 41 and taking into account sensing data received from the various assemblies of the vehicle tracking system, such as one or more of the LIDAR, RADAR and Stereo Vision assemblies. As previously discussed, collision avoidance is also effected by way of the pose data messages, and the processing thereof by the vehicle coordination assembly 33 to specify loading windows, loading bubbles, limits on pose, etc.

The method may include operating the vehicle coordination assembly 33 to track all machine actors in the area of interest, e.g. the region of the blasted bench material 3 illustrated in FIG. 1. In an exemplary embodiment the vehicle coordination system 33 effects collision avoidance whilst determining loading task assignments taking into account positions of all of the machine actors in the area of interest.

For example, with reference to FIG. 10 the vehicle coordination assembly may be configured by the task assignment program 70 to effect collision avoidance between the machine actors by allocating safe operation bounding boxes 91, 92 to the first and second loading vehicles. Consequently, the onboard vehicle control and tracking system 23 of the loading vehicles 4-1, 4-2, and similarly of other machine actors in the region, are made aware that they can proceed with minimal onboard collision detection so long as they operate within their allocated bounding box. As a result they may be able to move more quickly within the bounding boxes 90, 92 as collision avoidance processing can be minimized.

In the presently described exemplary embodiment the first and second sequences of tasks are determined by the vehicle coordination assembly 33 to prevent overlap of the safe operation bounding boxes at any given time to facilitate collision avoidance.

After a haul truck, e.g. truck 2-1 in FIG. 10, has been filled, the vehicle coordination assembly 33 can check that it is indeed loaded with material by monitoring load weight data in the information that is received from the vehicle control and tracking assembly 23 of the haul truck 2-1. Alternatively, the haul truck may simply transmit a “loading completed” message in its pose data messages 25. The vehicle coordination assembly sends a “move” command to the haul vehicle via the data network 31, which the haul truck responds to by moving away from the loading bay so that an empty truck can then take its place for further loading.

As previously mentioned, the vehicle coordination assembly 33 may store dimensions of the loading truck and of the first loading vehicle and the second loading vehicle in a data storage assembly. For example, the vehicle coordination assembly 33 may store those dimensions, and also the dimensions of other machine actors, such as those discussed with reference to FIG. 1 in a table 85 of a database 72, as shown in FIG. 7.

It will be realized that other embodiments are encompassed, for example, in one scenario a multiple (i.e., “N”) number of haul trucks are made available in a loading area. At least N+1 loading vehicles are provided. The vehicle coordination assembly 33 is configured to implement the dumping of material from the loading vehicles into one or more haul trucks. In a variant of the above example, each of the N+1 loading vehicles carry a known material type such as material grade, and the vehicle coordination assembly 33 is configured to implement the dumping of material into one or more haul trucks associated with that grade.

One or more embodiments discussed herein are of economic value because they provide one or more of the following advantages:
1. Allows simultaneous loading assignments to be assigned to loading vehicles for loading haul trucks, such as a smaller truck that can travel on a public road, from both sides of the truck.
2. Allows multiple loading vehicles, and other machine actors, to operate in close proximity to each other with minimal risk of accidents.
3. Allows a consistent flow of incoming and departing trucks.
4. Allows for use of smaller, more efficient excavators, for example front-end loaders, compared to existing larger mining excavators.
5. Increases attractiveness of frontend loaders as primary loading mechanism, which are more efficient than excavators.
6. Allows smaller haul trucks to operate on 3-6 m benches, in particular around 5 m, rather than 10 m+ benches when using existing mining trucks because the front-end loaders can operate on the smaller benches and the risk of collision is reduced. The bench dimensions that have been mentioned are for bench height and block size (where a bench can be subdivided into blocks). The overall width of a bench can also be decreased. Ordinarily to comfortably accommodate for ultra-class haul trucks bench widths are around 70 m+, but that can be reduced to around 50 m, for example.
7. Allows for Improved resolution of stockpiles.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described herein comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the scope of the invention.

1. A method to coordinate loading of material in an operational area by machine actors, including haul trucks and loading vehicles, the method comprising:
operating a vehicle coordination assembly to
establish data communications with vehicle sensing systems of the haul trucks and of the loading vehicles;
with reference to the data communications, determine load-ready haul trucks being haul trucks that are ready to be loaded;
for each load-ready haul truck, assign a loading task to two or more of the loading vehicles for loading of the load-ready haul truck, each task specifying a respective safe operating space in which a loading vehicle is restricted to operating; and
set the safe operating space in respect of one of the assigned loading vehicles to extend from a region of the material in the operational area over a side of the load-ready haul truck, whilst setting each safe operating space in respect of other of the assigned loading vehicles to fall short of a side of the haul truck,
whereby only the assigned loading vehicles with a safe operating space extending over the side of the haul truck performs a dumping operation to the haul truck at any one time; and
upon determining completion of the dumping operation, revising the safe operating spaces to allow a next loading vehicle to perform a dumping operation to the haul truck whilst preventing other loading vehicles from performing a dumping operation to the haul truck.

2. The method of claim 1, including operating the vehicle coordination assembly to track all the machine actors.

3. The method of claim 2, including operating the vehicle coordination assembly to facilitate collision avoidance whilst determining the respective safe operating space of each task by taking into account poses of all of the machine actors.

4. The method of claim 3, wherein the loading tasks specify respective safe operating spaces that are non-overlapping at any given time to effect the collision avoidance.

5. The method of claim 1, including operating the vehicle coordination assembly to send a move command to a haul truck upon determining that the haul truck has been fully loaded.

6. The method of claim 1, including operating the vehicle coordination assembly to send a move command to an unloaded haul truck to bring the unloaded haul truck to a position for loading by the two or more loading vehicles.

7. The method of claim 1, including storing dimensions of the haul trucks and of the loading vehicles in a data storage assembly of the vehicle coordination assembly.

8. The method of claim 7, including operating the vehicle coordination assembly to determine the safe operating spaces with reference to the dimensions of the haul trucks and loading vehicles.

9. The method of claim 1, wherein the loading vehicles comprise front-end loaders.

10. The method of claim 1, wherein the loading vehicles comprise one or more different types of loading vehicle.

11. The method of claim 1, including operating the vehicle coordination assembly to track at least two loading vehicles to avoid collision of a bucket of a first loading vehicle with a bucket of a second loading vehicle during implementation of each loading task.

12. The method of claim 1, wherein:
the vehicle sensing systems include LIDAR; and/or
the vehicle sensing systems the sensing systems include radar; and/or
the vehicle sensing systems include stereo vision cameras; and/or
the vehicle sensing systems includes joint encoders for ascertaining joint angles; and/or
one or more of the loading vehicles are autonomous; and/or
one or more of the haul trucks are autonomous.

13-17. (canceled)

18. The method of claim 1, wherein the haul trucks include Right Sized Autonomous Trucks (RSATs).

19. A system to coordinate loading of material in an operational area by machine actors including haul trucks and loading vehicles, the system comprising:
the haul trucks;
the loading vehicles for loading the haul trucks;
each haul truck and each loading vehicle having a vehicle sensing assembly in communication with a respective vehicle communication system, the vehicle communication system arranged to transmit pose data of the haul trucks and of the loading vehicles;
a vehicle coordination assembly in communication with said vehicle communication systems of the haul trucks and of the loading vehicles via a data network, the vehicle coordination assembly configured to:
establish data communications with vehicle sensing systems of the haul trucks and of the loading vehicles;
with reference to the data communications, determine load-ready haul trucks being haul trucks that are ready to be loaded;
for each load-ready haul truck, assign a loading task to two or more of the loading vehicles for loading of the load-ready haul truck, each task specifying a respective safe operating space in which a loading vehicle is restricted to operating; and
set the safe operating space in respect of one of the assigned loading vehicles to extend from a region of the material in the operational area over a side of the haul truck, whilst setting each safe operating space in respect of other of the assigned loading vehicles to fall short of a side of the haul truck,
whereby only the assigned loading truck with a safe operating space extending over the side of the haul truck performs a dumping operation to the haul truck at any one time; and
upon determining completion of the dumping operation, revising the safe operating spaces to allow a next loading vehicle to perform a dumping operation to the haul truck whilst preventing other loading vehicles from performing a dumping operation to the haul truck.

20. The system of claim 19, wherein the vehicle coordination assembly is configured to assign loading tasks specifying respective safe operating spaces that are non-overlapping at any given time to effect collision avoidance of the machine actors.

21. The system of claim 19, wherein the vehicle coordination assembly is configured to send a move command to a haul truck upon determining that the haul truck has been fully loaded and/or to send a move command to an unloaded haul truck to bring the unloaded haul truck to a position for loading by the two or more loading vehicles.

22. The system of claim 19, including a data storage assembly storing dimensions of the haul trucks and the loading vehicles.

23. The system of claim 22, wherein the vehicle coordination assembly is configured to determine the safe operating spaces with reference to the dimensions of the haul trucks and loading vehicles.

24. The system of claim 19, wherein at least two loading vehicles comprise front end loaders and wherein the vehicle coordination assembly is configured to track the at least two loading vehicles to avoid collision of a bucket of a first loading vehicle with a bucket of a second loading vehicle during implementation of each loading task.

25. A method to load a haul truck with material by operating first and second loading vehicles, the method comprising:
determining a position of the haul truck in a state of readiness for loading;
for each of the first and second loading vehicles assigning first and second loading tasks to transfer material into the haul truck
the first and second loading tasks progressing from loading buckets of the first and second loading vehicles to dumping loads from the buckets into the haul truck wherein the first and second loading tasks specify respective safe operating spaces for the first and second vehicles to cause the first and second loading vehicles to dump from opposite sides of the haul truck at separate times.
